(19) United States
(12) Patent Application Publication
(10) Pub. No.: US 2011/0225559 A1
(43) Pub. Date: Sep. 15, 2011

(54) LOGIC VERIFYING APPARATUS, LOGIC VERIFYING METHOD, AND MEDIUM

(75) Inventor: Takeo NISHIDE, Kawasaki-shi (JP)

(73) Assignee: KABUSHIKI KAISHA TOSHIBA, Tokyo (JP)

(21) Appl. No.: 12/881,035

(22) Filed: Sep. 13, 2010

(30) Foreign Application Priority Data
Mar. 9, 2010 (JP) 2010-51891

(51) Int. Cl. G06F 9/455; G06F 17/50

(52) U.S. Cl. 716/106

(57) ABSTRACT

According to one embodiment, a logic verifying apparatus includes an input module, an extracting module, a table generator, and a verification information generator. The input module is configured to accept a first assertion and a first test pattern. The extracting module is configured to extract a definite rule assertion and a hold rule assertion by analyzing the first assertion accepted by the input module. The table generator is configured to generate a rule table indicating a relationship between the definite condition and a signal of the verification object circuit based on the definite rule assertion and hold rule assertion extracted by the extracting module. The verification information generator is configured to generate verification information used to verify a non-formulation behavior of the verification object circuit based on the rule table generated by the table generator.

### CROSS REFERENCE TO RELATED APPLICATIONS

This application is based upon and claims the benefit of priority from the prior Japanese Patent Application No. 2010-51891, filed on Mar. 9, 2010, the entire contents of which are incorporated herein by reference.

### FIELD

The present invention relates to a logic verifying apparatus, a logic verifying method, and a medium.

### BACKGROUND

Recently, customizable on-chip buses such as an OCP (Open Core Protocol) and an AMBA (Advanced Microcontroller Bus Architecture) are widely used.

A specification document in which functions of a semiconductor device are described and a check list such as compliance in which a specification determined in each function is described are prepared in such on-chip buses. Ordinarily, the compliance is provided from a vender who produces a general-purpose assertion. Accordingly, a user can perform a simulation, an emulation, and a formal check to perform logic verification of an RTL (Register Transfer Level) description, using the check list provided from the vender. In that case, it is not required that the user produces the check list.

However, in the specification document provided from the vender, although a behavior (hereinafter referred to as “formulation behavior”) of a sending device that sends a signal is described under a valid condition, a behavior of the sending device under an invalid condition, a behavior of a receiving device that receives the signal under the valid condition, and a behavior (hereinafter referred to as “non-formulation behavior”) of the receiving device under the invalid condition are not described.

On the other hand, there is well known a technique of generating an assertion (see JP-A No. 2007-264994 (Kokai)). However, the assertion that detects a violation of the non-formulation behavior cannot be generated even if the technique disclosed in JP-A No. 2007-264994 (Kokai) is used.

Accordingly, the violation of the non-formulation behavior cannot be detected even if the conventional general-purpose assertion is used. That is, the result of logic verification of the non-formulation behavior is not included in the result of logic verification of the result of logic verification of the RTL description, in which the conventional general-purpose assertion is used. When the conventional assertion is used, the result of logic verification becomes incomplete. Therefore, a time loss and an economic loss are increased in designing the semiconductor device.

### BRIEF DESCRIPTION OF THE DRAWINGS

FIG. 1 is a block diagram illustrating a configuration of a system including a logic verifying apparatus 10 of the first embodiment.

FIG. 2 is a block diagram illustrating a configuration of the logic verifying apparatus 10 of FIG. 1.

FIG. 3 is a flowchart illustrating a procedure of a logic verification operation of the first embodiment.

FIG. 4 is a flowchart illustrating a procedure of generating table (S303) of FIG. 3.

FIG. 5 is a schematic diagram illustrating a structure of a definite rule table generated in S401 and S403 of FIG. 4.

FIG. 6 is a schematic diagram illustrating a structure of a hold rule table generated in S404 to S407 of FIG. 4.

FIG. 7 is a schematic diagram illustrating a structure of a definite rule table generated in S408 and S409 of FIG. 4.

FIG. 8 is a schematic diagram illustrating an example of the second assertion 94 corresponding to the definite rule table of FIG. 7.

FIG. 9 is a schematic diagram illustrating an example of the second assertion 94 corresponding to the hold rule table of FIG. 6.

FIG. 10 is a block diagram illustrating a configuration of a system including the logic verifying apparatus 10 of the second embodiment.

FIG. 11 is a flowchart illustrating a procedure in generating verification information (S304 of FIG. 3) of the second embodiment.

FIG. 12 is a schematic diagram illustrating an example of the first assertion 92 used in S1102 of FIG. 11.

FIG. 13 is a schematic diagram illustrating an example of the second test pattern 97 corresponding to the first assertion 92 of FIG. 12.

FIG. 14A is a schematic diagram illustrating a signal waveform of the first test pattern 93.

FIG. 14B is a schematic diagram illustrating a signal waveform of the second test pattern 97.

### DETAILED DESCRIPTION

Embodiments will now be explained with reference to the accompanying drawings.

In general, according to one embodiment, a logic verifying apparatus includes an input module, an extracting module, a table generator, and a verification information generator. The input module is configured to accept a first assertion and a first test pattern. The first assertion includes a first premise description indicating a first premise of a formulation behavior of a verification object circuit and a first specification description indicating a first specification of the formulation behavior based on the first premise. The first test pattern is used to verify the formulation behavior of the verification object circuit. The extracting module is configured to extract a definite rule assertion and a hold rule assertion by analyzing the first assertion accepted by the input module. The definite rule assertion indicates a definite condition used to define a signal value of the verification object circuit. The hold rule assertion indicates a hold condition used to hold the signal value of the verification object circuit. The table generator is configured to generate a rule table indicating a relationship between the definite condition and a signal of the verification object circuit based on the definite rule assertion and hold rule assertion extracted by the extracting module. The verification information generator is configured to generate verification information used to verify a non-formulation behavior of the verification object circuit based on the rule table generated by the table generator. The non-formulation behavior is not included in the first assertion and the first test pattern.

### First Embodiment

A logic verifying apparatus according to a first embodiment will be explained below. The logic verifying apparatus of the first embodiment generates a second assertion concerning a non-formulation behavior from a first assertion concerning a formulation behavior.

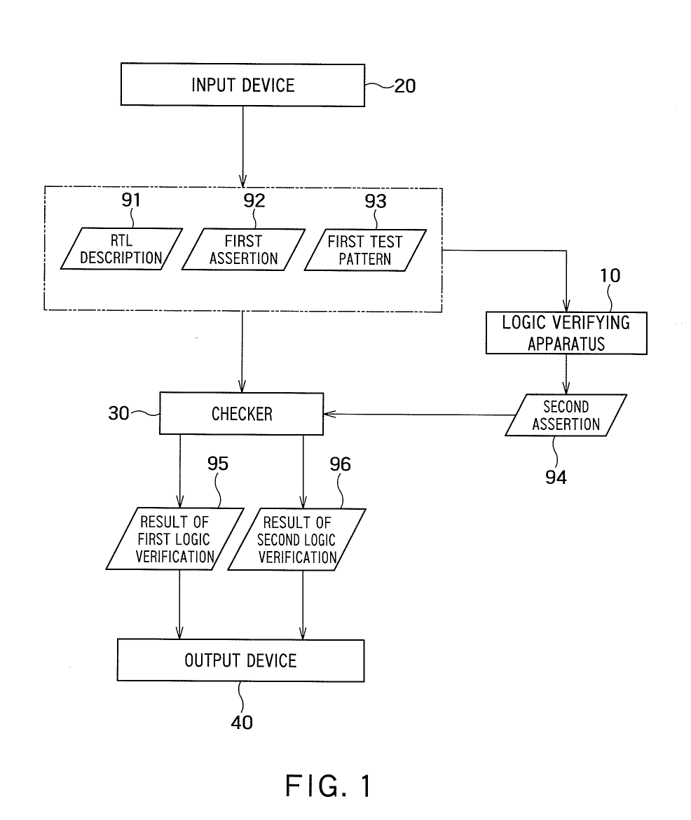

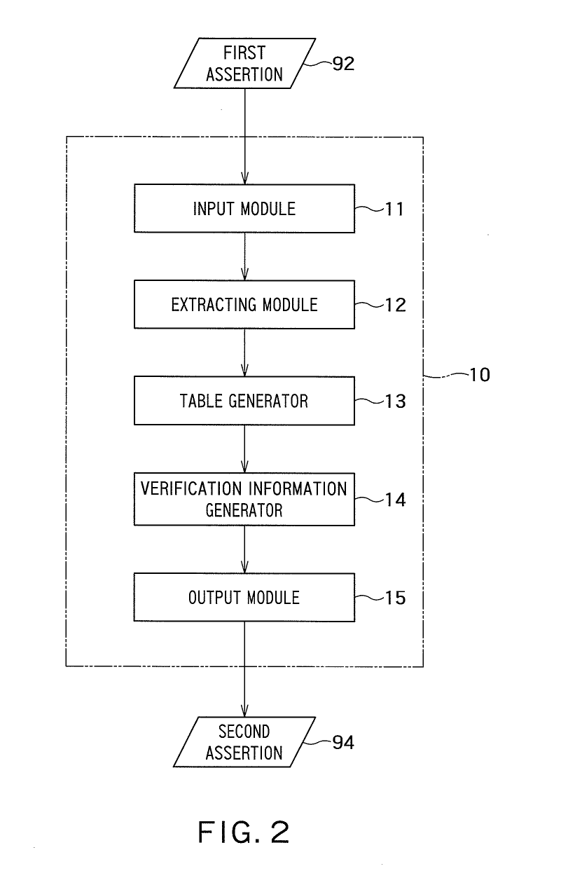

A configuration of the logic verifying apparatus of the first embodiment will be explained. FIG. 1 is a block diagram illustrating a configuration of a system including a logic verifying apparatus 10 of the first embodiment. FIG. 2 is a block diagram illustrating a configuration of the logic verifying apparatus 10 of FIG. 1.

The system of FIG. 1 includes the logic verifying apparatus 10, an input device 20, a checker 30, and an output device 40.

The input device 20 of FIG. 1 is configured to accept an RTL description 91, a first assertion 92, and a first test pattern 93, which are fed by a user. The RTL description 91 is a circuit description indicating a verification object circuit. The first assertion 92 includes a plurality of operating conditions that specify the formulation behavior of the verification object circuit. Each operating condition includes a first premise description indicating a first premise of the formulation behavior of the verification object circuit and a first specification description indicating a first specification of the formulation behavior based on the first premise. For example, the input device 20 is a keyboard or a communication device. For example, the first assertion 92 is included in a compliance provided from a vender. For example, the first test pattern 93 is one that is used to verify the formulation behavior of the verification object circuit.

The logic verifying apparatus 10 of FIG. 1 is configured to generate the second assertion 94 based on the first assertion 92 accepted by the input device 20. The second assertion 94 includes a plurality of operating conditions that specify the non-formulation behavior of the verification object circuit. Each operating condition includes a second premise description indicating a premise of the non-formulation behavior that is not included in the first premise of behaviors of the verification object circuit and a second specification description indicating a second specification of the non-formulation behavior based on the second premise. Referring to FIG. 2, the logic verifying apparatus 10 includes an input module 11, an extracting module 12, a table generator 13, a verification information generator 14, and an output module 15.

The input module 11 of FIG. 2 is configured to accept the RTL description 91, the first assertion 92, and the first test pattern 93 that are accepted by the input device 20. That is, the input module 11 is an interface between the logic verifying apparatus 10 and the input device 20.

The extracting module 12 of FIG. 2 is configured to extract a definite rule assertion and a hold rule assertion by analyzing the first assertion 92 accepted by the input module 11. The definite rule assertion indicates a condition (hereinafter referred to as “definite condition”) that defines a signal value of the verification object circuit as 0 or 1. The hold rule assertion indicates a condition (hereinafter referred to as “hold condition”) that holds the signal value of the verification object circuit.

The table generator 13 of FIG. 2 is configured to generate a rule table indicating a relationship between the definite condition and the signal of the verification object circuit based on the definite rule assertion and hold rule assertion that are extracted by the extracting module 12. For example, the table generator 13 registers the definite condition including “valid condition” and “invalid condition” in a rule table. The valid condition is one that is used to notify another device that the signal is valid. The invalid condition is one that is used to notify another device that the signal is invalid. Each of the valid condition and the invalid condition includes a signal name and a signal value. Then, the table generator 13 registers the signal values of the sending device that sends the signal based on the definite rule assertion under the “valid condition” and “invalid condition” into the rule table. Then, the table generator 13 registers the signal values of the receiving device that receives the signal based on the hold rule assertion under the “valid condition” and “invalid condition” into the rule table. For example, when a processor writes data in a memory, the processor is the sending device and the memory is the receiving device.

The verification information generator 14 of FIG. 2 is configured to generate verification information used to verify the non-formulation behavior of the verification object circuit, which is not included in the first assertion 92 and the first test pattern 93, based on the rule table generated by the table generator 13. For example, the verification information generator 14 generates the second assertion 94.

The output module 15 of FIG. 2 is configured to supply the verification information including the second assertion 94 generated by the verification information generator 14 to the checker 30. That is, the output module 15 is an interface between the logic verifying apparatus 10 and the output device 40.

The checker 30 of FIG. 1 performs logic verification of the formulation behavior of the RTL description 91 based on the first assertion 92 and first test pattern 93 that are accepted by the input device 20. Therefore, a result of first logic verification 95 is generated. Further, the checker 30 performs logic verification of the non-formulation behavior of the RTL description 91 based on the first test pattern 93 that is accepted by the input device 20 and the second assertion 94 that is generated by the logic verifying apparatus 10. Therefore, a result of second logic verification 96 is generated. For example, the checker 30 is an existing tool such as a simulator, an emulator, and a formal checker.

The output device 40 of FIG. 1 is configured to output the result of first logic verification 95 and result of second logic verification 96 that are generated by the checker 30. For example, the output device 40 is a display or a communication device.

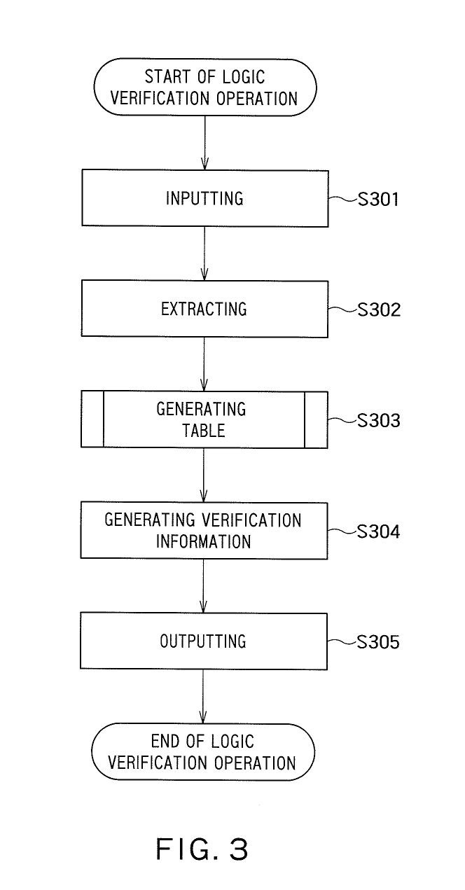

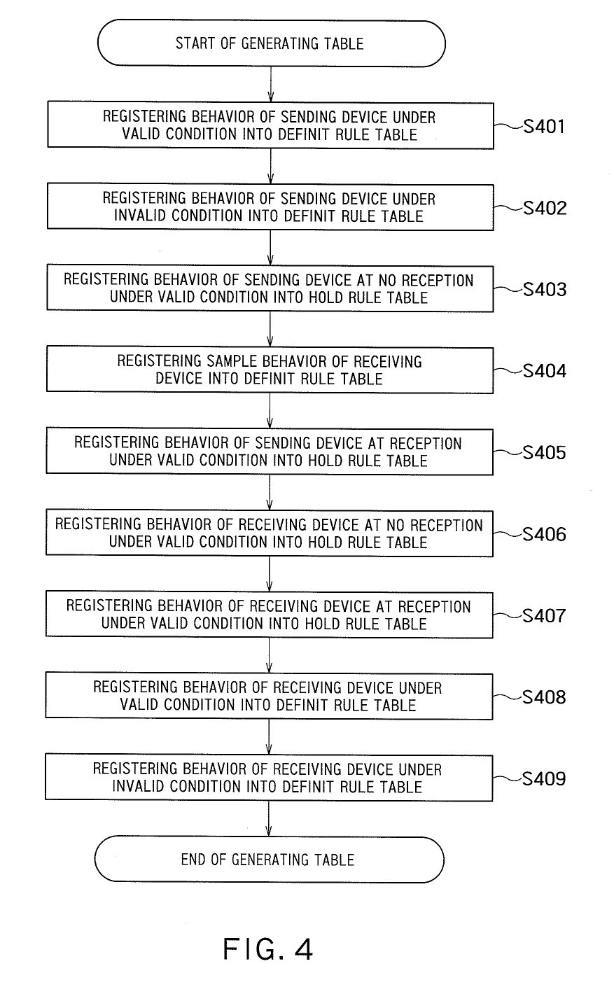

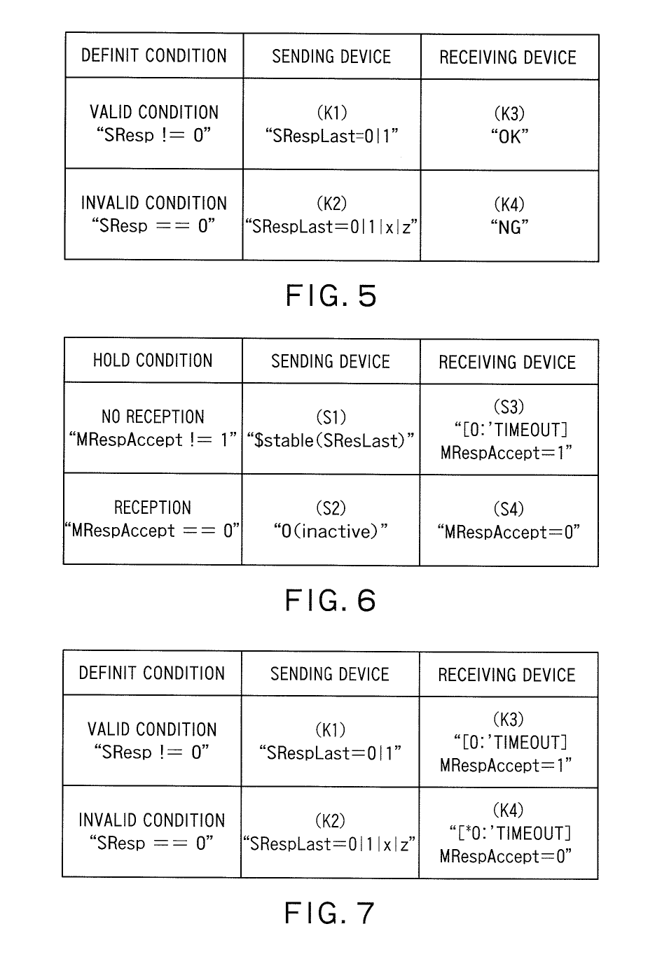

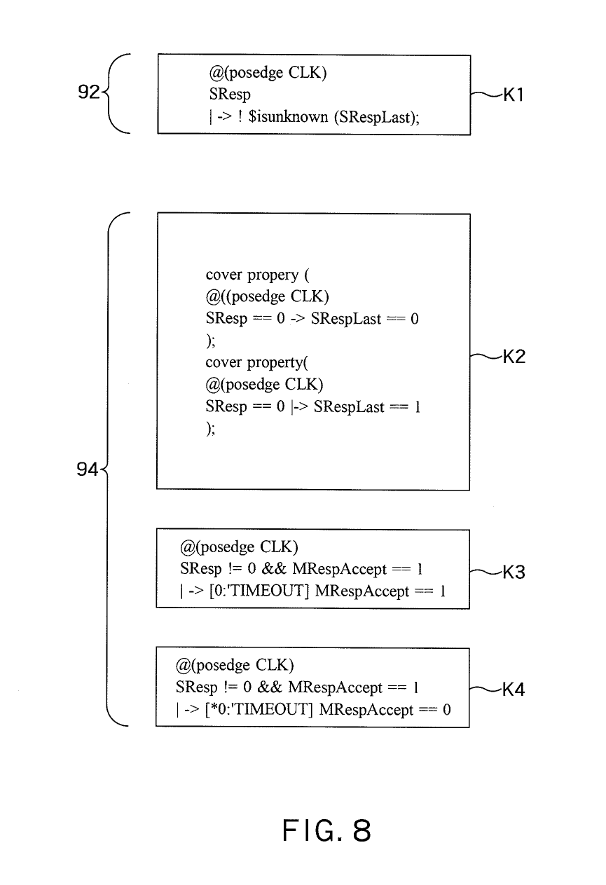

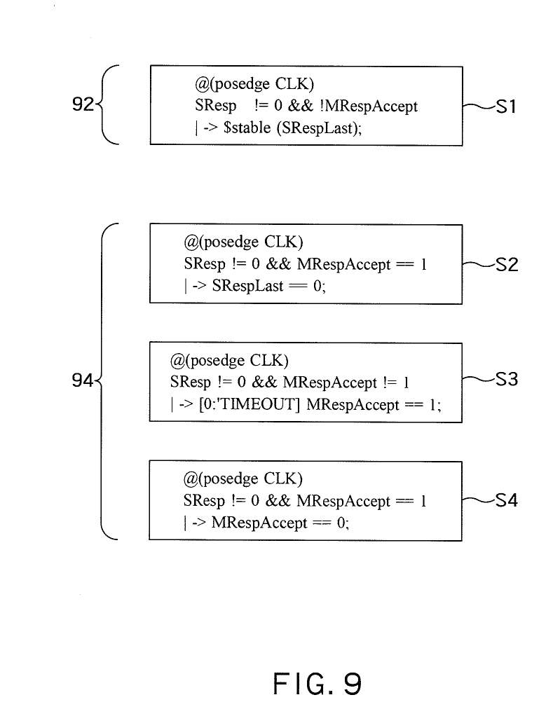

An operation of the logic verifying apparatus of the first embodiment will be explained below. FIG. 3 is a flowchart illustrating a procedure of a logic verification operation of the first embodiment. FIG. 4 is a flowchart illustrating a procedure of generating table (S303) of FIG. 3. FIG. 5 is a schematic diagram illustrating a structure of a definite rule table generated in S401 and S403 of FIG. 4. FIG. 6 is a schematic diagram illustrating a structure of a hold rule table generated in S404 to S407 of FIG. 4. FIG. 7 is a schematic diagram illustrating a structure of a definite rule table generated in S408 and S409 of FIG. 4. FIG. 8 is a schematic diagram illustrating an example of the second assertion 94 corresponding to the definite rule table of FIG. 7. FIG. 9 is a schematic diagram illustrating an example of the second assertion 94 corresponding to the hold rule table of FIG. 6.

<FIG. 3: INPUT (S301)>

The input module 11 accepts the RTL description 91, the first assertion 92, and the first test pattern 93. Therefore, the information necessary for the logic verification operation is supplied to the logic verifying apparatus 10.

<FIG. 3: EXTRACTING (S302)>

The extracting module 12 extracts the definite rule assertion and the hold rule assertion by analyzing the first assertion 92 accepted in input (S301). The definite rule assertion indicates the definite rule (known rule) of a signal (hereinafter referred to as “handshake signal”) associated with handshake of a standard protocol such as an OCP and an AMBA. The hold rule assertion indicates the hold rule (stable rule) of the handshake signal.

<FIG. 3: GENERATING TABLE (S303)>

The table generator 13 generates the rule table indicating the relationship between the definite condition and the signal of the verification object circuit based on the definite rule assertion and hold rule assertion that are extracted in extracting (S302). At this point, the table generator 13 generates the rule table in consideration of the non-formulation rule that is not described in a specification document provided from the vender. The non-formulation rule is one that is determined based on a logical premise in the protocol associated with the handshake. In other words, the non-formulation rule indicates a rule concerning the behavior of the device (sending device and receiving device) under the definite condition (“valid condition” and “invalid condition”) in the definite rule and a rule concerning the behavior of the device (sending device and receiving device) under the hold condition (“reception” and “no reception”) in the hold rule. The behavior of the sending device under the “invalid condition”, the behaviors of the receiving device under the “valid condition” and “invalid condition”, the behavior of the sending device at reception, and the behaviors of the receiving device at reception and no reception are defined in the non-formulation rule.

Generating table (S303) of FIG. 3 will be explained.

In the definite rule of FIG. 5, the description of the “valid condition” is “SResp!=0” and the description of the “invalid condition” is “SResp==0”. In the hold rule of FIG. 6, the description of the “no reception” is “MRespAccept!=1” and the description of the “reception” is “MRespAccept==0”.

<FIG. 4: S401>

The table generator 13 extracts the behavior of the sending device under the “valid condition” and registers the extracted behavior in the definite rule table. For example, “SRespLast=0|1” that is indicative of the behavior of the sending device under the “valid condition” is registered in the definite rule table ((K1) of FIG. 5).

<FIG. 4: S402>

The table generator 13 extracts the behavior under the “invalid condition” of the sending device and registers the extracted behavior in the definite rule table. For example, “SRespLast=0|1|x|z” that is indicative of the behavior of the sending device under the “invalid condition” is registered in the definite rule table ((K2) of FIG. 5).

<FIG. 4: S403>

The table generator 13 registers sample behaviors of the sending device under the “valid condition” and under the “invalid condition” in the definite rule table. The behaviors of the sending device under the “valid condition” and under the “invalid condition” are determined based on the hold rule. Accordingly, in S403, the sample behavior is registered. For example, “OK” that is indicative of the sample behavior of the receiving device under the “valid condition” and “NG” that is indicative of the sample behavior of the receiving device under the “invalid condition” are registered in the definite rule table ((K3) and (K4) of FIG. 5)

<FIG. 4: S404>.

The table generator 13 extracts the behavior of the sending device at “no reception” and registers the extracted behavior in the hold rule table. For example, “$stable (SRespLast)” that is indicative of the behavior of the sending device at the “no reception” is registered in the hold rule table ((S1) of FIG. 6).

<FIG. 4: S405>

The table generator 13 extracts the behavior of the sending device at the “reception” and registers the extracted behavior in the hold rule table. For example, “0 (inactive)” that is indicative of the behavior of the sending device at the “reception” is registered in the hold rule table ((S2) of FIG. 6).

<FIG. 4: S406>

The table generator 13 extracts the behavior of the receiving device at the “no reception” and registers the extracted behavior in the hold rule table. For example, “[0:′ TIMEOUT] MRespAccept=1” that is indicative of the behavior of the receiving device at the “no reception” is registered in the hold rule table ((S3) of FIG. 6).

<FIG. 4: S407>

The table generator 13 extracts the behavior of the receiving device at the “reception” and registers the extracted behavior in the hold rule table. For example, “MRespAccept=0” that is indicative of the behavior of the receiving device at the “reception” is registered in the hold rule table ((S4) of FIG. 6). Therefore, the hold rule table is completed.

<FIG. 4: S408>

The table generator 13 extracts the behavior of the receiving device under the “valid condition” using the hold rule table and registers the extracted behavior in the definite rule table. For example, “[0:′ TIMEOUT] MRespAccept=1” that is indicative of the behavior of the receiving device under the “valid condition” is registered in the definite rule table ((K3) of FIG. 7).

<FIG. 4: S409>

The table generator 13 extracts the behavior of the receiving device under the “invalid condition” using the hold rule table and registers the extracted behavior in the definite rule table. For example, “[*0:′ TIMEOUT] MRespAccept=0” that is indicative of the behavior of the receiving device under the “invalid condition” is registered in the definite rule table ((K4) of FIG. 7). Therefore, the definite rule table is completed.

Generating table of FIG. 4 is ended after the definite rule table and the hold rule table are completed.

In FIG. 4, the table generator 13 derives the behavior of the sending device based on the definite rule, derives the behaviors of the sending device and the receiving device based on the hold rule, and derives the behavior of the receiving device based on the definite rule using the hold rule. Therefore, the definite rule and the hold rule of the non-formulation behavior are determined.

<FIG. 3: GENERATING VERIFICATION INFORMATION (S304)>

The verification information generator 14 generates the second assertion 94 that is the verification information used to verify the non-formulation behavior of the verification object circuit, which is not included in the first assertion 92 and first test pattern 93, based on the definite rule table and hold rule table that are generated in generating table (S303). For example, the second assertion 94 ((K2) to (K4)) of FIG. 8 is generated from the definite rule table of FIG. 7, and the second assertion 94 ((S2) to (S4)) of FIG. 9 is generated from the hold rule table of FIG. 6. K2 to K4 of FIG. 8 correspond to K2 to K4 of FIG. 7, respectively. S2 to S4 of FIG. 9 correspond to S2 to S4 of FIG. 6, respectively.

<FIG. 3: OUTPUT (S305)>

The output module 15 supplies the verification information including the second assertion 94 generated in generating verification information (S304) to the checker 30.

The logic verification operation of FIG. 3 is ended after output (S305).

According to the first embodiment, the second assertion 94 concerning the non-formulation behavior is generated from the first assertion 92 concerning the formulation behavior. Then, the result of second logic verification 96 is generated based on the second assertion 94. The result of second logic verification 96 includes the result of logic verification of the non-formulation behavior that is not included in the first assertion 92. Accordingly, the incompletion of the result of logic verification can be reduced. As a result, the time loss and the economic loss can be reduced in designing the semiconductor device.

According to the first embodiment, the information that should be provided by the user is similar to the case where the result of first logic verification 95 is generated using only the first assertion 92. That is, as is conventionally done, the user can obtain both the results of the first logic verification 95 and the second logic verification 96 by feeding the RTL description 91, the first assertion 92, and the first test pattern 93. In other words, the logic verifying apparatus 10 can be used while combined with any checker 30 such as the existing simulator, emulator, and property checker.

### Second Embodiment

A logic verifying apparatus according to a second embodiment will be explained below. The logic verifying apparatus of the second embodiment generates a second test pattern concerning the non-formulation behavior from the first assertion concerning the formulation behavior. The description of contents similar to those of the first embodiment will not be repeated.

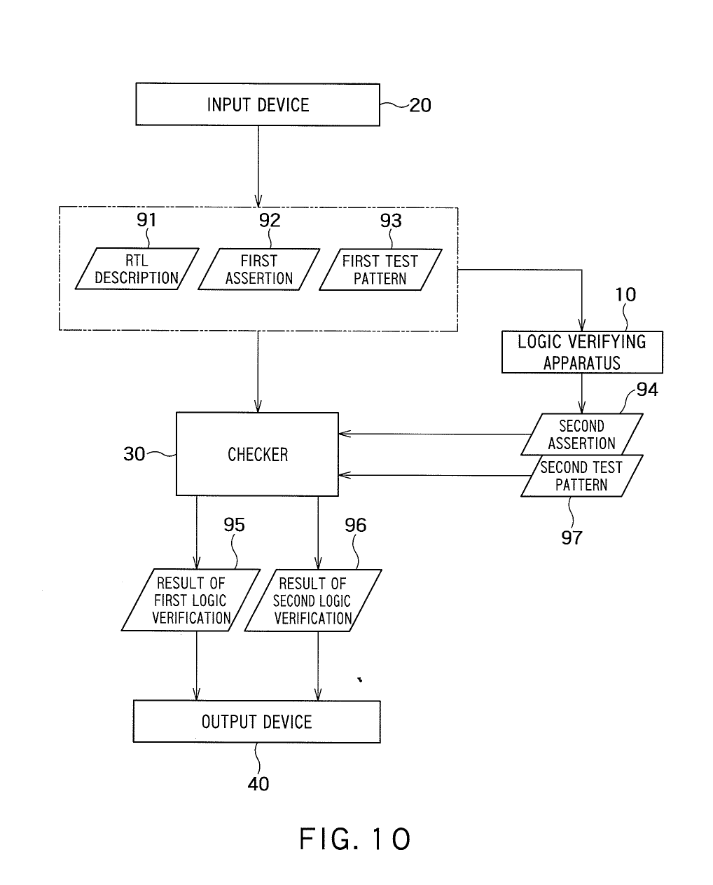

A configuration of the logic verifying apparatus of the second embodiment will be explained. FIG. 10 is a block diagram illustrating a configuration of a system including the logic verifying apparatus 10 of the second embodiment.

The system of FIG. 10 includes the logic verifying apparatus 10, the input device 20, the checker 30, and the output device 40. The input device 20 and the output device 40 are similar to those of the first embodiment.

The logic verifying apparatus 10 of FIG. 10 is configured to generate a second test pattern 97 based on the first test pattern 93 accepted by the input device 20. For example, the second test pattern 97 is one that is used to verify the non-formulation behavior of the verification object circuit.

The verification information generator 14 of the second embodiment is configured to generate the verification information including the second assertion 94 and the second test pattern 97 based on the rule table generated by the table generator 13. The second assertion 94 is used to verify the non-formulation behavior of the verification object circuit, which is not included in the first assertion 92 and the first test pattern 93. In the second test pattern 97, the signal value is randomly determined when the signal is invalid in the first test pattern 93.

The output module 15 of the second embodiment is configured to supply the verification information including the second assertion 94 and the second test pattern 97, which is generated by the verification information generator 14, to the checker 30.

The checker 30 of FIG. 10 performs the logic verification of the formulation behavior of the RTL description 91 based on the first assertion 92 and the first test pattern 93 that are accepted by the input device 20. Therefore, the result of first logic verification 95 is generated. The checker 30 also performs the logic verification of the non-formulation behavior of the RTL description 91 based on the second test pattern 97 and the second assertion 94 that are generated by the logic verifying apparatus 10. Therefore, the result of second logic verification 96 is generated. For example, the checker 30 is an existing tool such as a simulator, an emulator, and a formal checker.

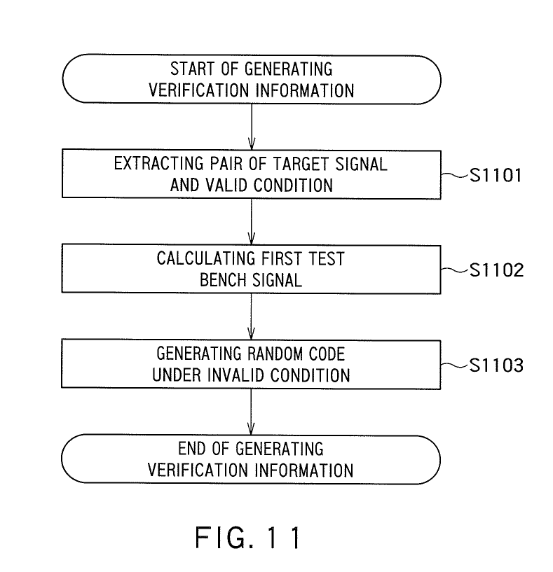

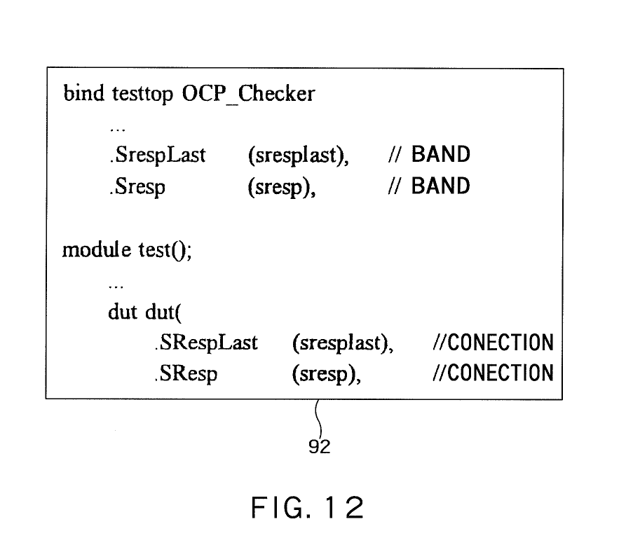

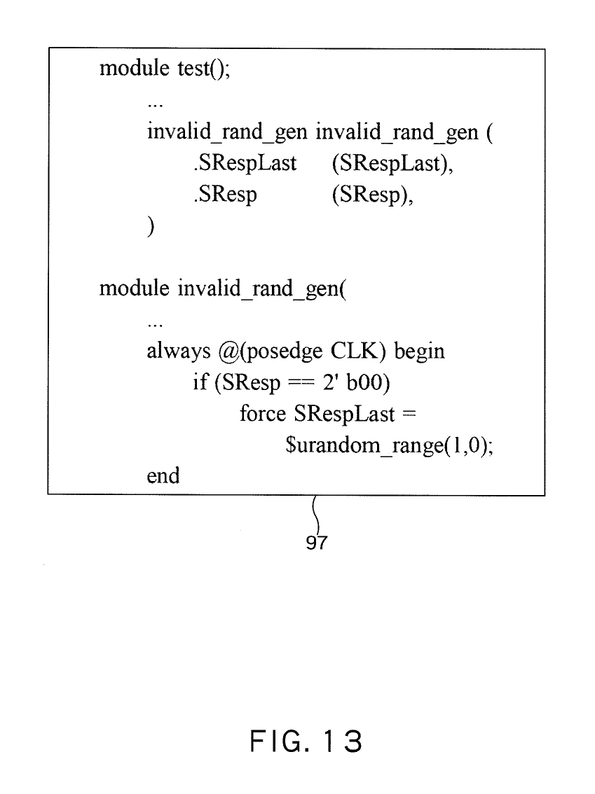

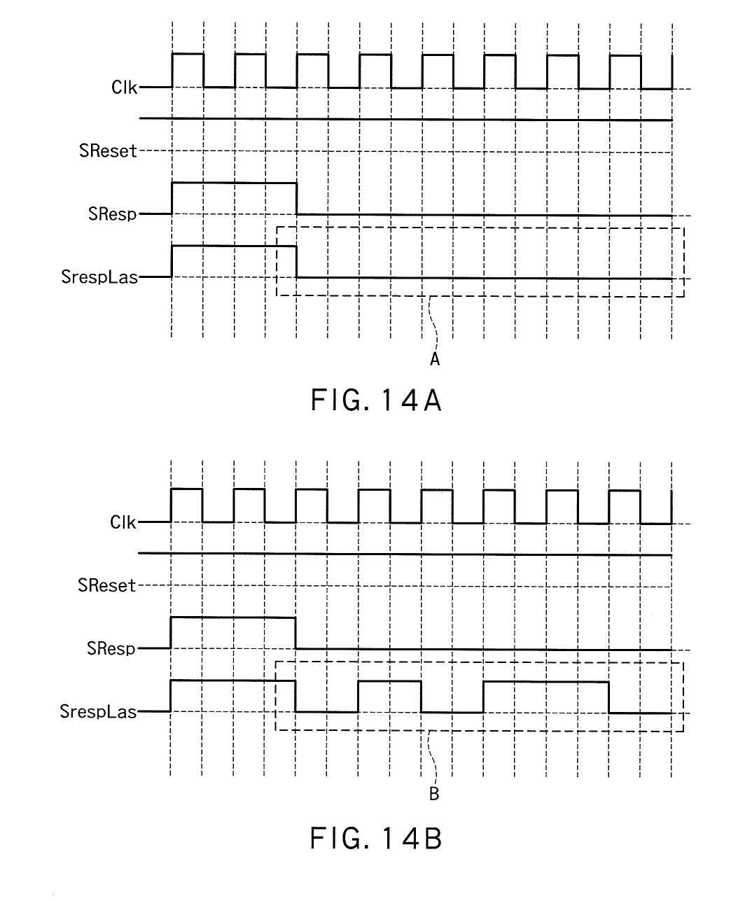

An operation of the logic verifying apparatus of the second embodiment will be explained. The logic verification operation of the second embodiment is performed in the procedure similar to that of the logic verification operation of the first embodiment of FIG. 3. FIG. 11 is a flowchart illustrating a procedure in generating verification information (S304 of FIG. 3) of the second embodiment. FIG. 12 is a schematic diagram illustrating an example of the first assertion 92 used in S1102 of FIG. 11. FIG. 13 is a schematic diagram illustrating an example of the second test pattern 97 corresponding to the first assertion 92 of FIG. 12. FIG. 14A is a schematic diagram illustrating a signal waveform of the first test pattern 93. FIG. 14B is a schematic diagram illustrating a signal waveform of the second test pattern 97.

Generating verification information of the second embodiment will be explained.

<FIG. 11: S1101>

The verification information generator 14 extracts a pair of the description indicating the object signal and the description indicating the “valid condition” from the definite rule table (see FIG. 7) generated in generating table (S303). The object signal is the handshake signal. The definite rule and the hold rule are applied to the object signal. For example, the description indicating the object signal is “SrespLast” (see (K1) of FIG. 7) and the description indicating the “valid condition” is “Sresp!=0” (see FIG. 7).

<FIG. 11: S1102>

The verification information generator 14 calculates a first test-bench signal. More specifically, the verification information generator 14 determines a correspondence relationship between the signal used in the first assertion 92 and an instance of the RTL description 91 from a bind of the first assertion 92. Then, the verification information generator 14 determines a correspondence relationship between the instance of the RTL description 91 and a test-bench signal used in the first test pattern 93 from a connection of the first assertion 92. Therefore, the test-bench signal is calculated. The test-bench signal includes a force object signal and a sampling object signal (see FIG. 12). In FIG. 12, the force object signal is “SRespLast” and the sampling object signal is “SResp”.

<FIG. 11: S1103>

The verification information generator 14 generates a random code with respect to each object signal to force the value of the force object signal using a random value under the “invalid condition” (see FIG. 13).

The generating verification information of the second embodiment is ended after S1103. As a result, the second assertion 94 that is indicative of the verification information is generated based on the definite rule table and the hold rule table that are generated in generating table (S303). The second assertion 94 is used to verify the non-formulation behavior of the verification object circuit, which is not included in the first assertion 92 and the first test pattern 93. Further, the second test pattern 97 corresponding to the random code generated in generating test pattern (S304) is generated.

In the conventional logic verification, as illustrated in FIG. 14A, an inactive value appears in a predetermined region (broken line A of FIG. 14A) of the first test pattern 93. Accordingly, the result of logic verification cannot be obtained in the region (that is, the region where the inactive value appears in the test pattern) indicated by the broken line A of FIG. 14A.

On the other hand, in the second embodiment, random values appear in a predetermined region (broken line B of FIG. 14B) of the second test pattern 97 as illustrated in FIG. 14B. The predetermined region (broken line B) is one in which the inactive value appears in the first test pattern 93. Accordingly, the result of logic verification (that is, the result of second logic verification 96) can also be obtained with respect to the region (that is, the region where the inactive value appears in the test pattern) indicated by the broken line B of FIG. 14B.

According to the second embodiment, the random code is generated with respect to the region where the inactive value appears in the test pattern, and the second test pattern 97 is generated based on the random code. Accordingly, the result of logic verification, which cannot be obtained by the conventional technique, can be obtained with respect to the region where the inactive value appears. That is, the incompletion of the result of logic verification can be reduced, and therefore, the time loss and the economic loss can be reduced in designing the semiconductor device.

In the second embodiment, the generation of the second assertion 94 may be eliminated. In such cases, the result of second logic verification 96 is obtained with respect to the region where the inactive value appears in the test pattern based on the first assertion 92 and the second test pattern 97.

At least a portion of the logic verifying apparatus 10 according to the above-described embodiments may be composed of hardware or software. When at least a portion of the logic verifying apparatus 10 is composed of software, a program for executing at least some functions of the logic verifying apparatus 10 may be stored in a recording medium, such as a flexible disk or a CD-ROM, and a computer may read and execute the program. The recording medium is not limited to a removable recording medium, such as a magnetic disk or an optical disk, but it may be a fixed recording medium, such as a hard disk or a memory.

In addition, the program for executing at least some functions of the logic verifying apparatus 10 according to the above-described embodiment may be distributed through a communication line (which includes wireless communication) such as the Internet. In addition, the program may be encoded, modulated, or compressed and then distributed by wired communication or wireless communication such as the Internet. Alternatively, the program may be stored in a recording medium, and the recording medium having the program stored therein may be distributed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A logic verifying apparatus comprising:
an input module configured to accept a first assertion and a first test pattern, the first assertion comprising:
(a) a first premise description indicating a first premise of a formulation behavior of a verification object circuit, and
(b) a first specification description indicating a first specification of the formulation behavior based on the first premise,
wherein the first test pattern is used to verify the formulation behavior of the verification object circuit;
an extracting module configured to extract a definite rule assertion and a hold rule assertion by analyzing the first assertion accepted by the input module, wherein the definite rule assertion indicates a definite condition used to define a signal value of the verification object circuit and the hold rule assertion indicates a hold condition used to hold the signal value of the verification object circuit;
a table generator configured to generate a rule table indicating a relationship between the definite condition and a signal of the verification object circuit based on the definite rule assertion and the hold rule assertion extracted by the extracting module; and
a verification information generator configured to generate verification information used to verify a non-formulation behavior of the verification object circuit which is not included in the first assertion and the first test pattern, based on the rule table generated by the table generator.

2. The apparatus of claim 1, wherein the table generator registers, in the rule table:
(a) a valid condition and an invalid condition of the definite condition,
(b) the signal values of a sending device sending the signal based on the definite rule assertion under the valid condition and the invalid condition, and
(c) the signal values of a receiving device receiving the signal based on the hold rule assertion under the valid condition and the invalid condition.

3. The apparatus of claim 1, wherein the verification information generator generates a second assertion based on the rule table generated by the table generator, the second assertion comprising a second premise description indicating a second premise of the non-formulation behavior of the verification object circuit and a second specification description indicating a second specification of the non-formulation behavior based on the second premise.

4. The apparatus of claim 2, wherein the verification information generator generates a second assertion based on the rule table generated by the table generator, the second assertion comprising a second premise description indicating a second premise of the non-formulation behavior of the verification object circuit and a second specification description indicating a second specification of the non-formulation behavior based on the second premise.

5. The apparatus of claim 1, wherein the verification information generator generates, based on the rule table, a second test pattern in which the signal value is randomly determined when the signal is invalid in the first test pattern.

6. The apparatus of claim 2, wherein the verification information generator generates, based on the rule table, a second test pattern in which the signal value is randomly determined when the signal is invalid in the first test pattern.

7. The apparatus of claim 3, wherein the verification information generator generates, based on the rule table, a second test pattern in which the signal value is randomly determined when the signal is invalid in the first test pattern.

8. The apparatus of claim 4, wherein the verification information generator generates, based on the rule table, a second test pattern in which the signal value is randomly determined when the signal is invalid in the first test pattern.

9. A logic verifying method comprising:
accepting a first assertion and a first test pattern, the first assertion comprising:
(a) a first premise description indicating a first premise of a formulation behavior of a verification object circuit, and
(b) a first specification description indicating a first specification of the formulation behavior based on the first premise,
wherein the first test pattern is used to verify the formulation behavior of the verification object circuit;
extracting a definite rule assertion and a hold rule assertion by analyzing the first assertion accepted by the input module, wherein the definite rule assertion indicates a definite condition used to define a signal value of the verification object circuit and the hold rule assertion indicates a hold condition used to hold the signal value of the verification object circuit;
generating a rule table indicating a relationship between the definite condition and a signal of the verification object circuit based on the definite rule assertion and the hold rule assertion extracted by the extracting module; and
generating verification information used to verify a non-formulation behavior of the verification object circuit which is not included in the first assertion and the first test pattern, based on the rule table generated by the table generator.

10. The method of claim 9, wherein generating the rule table comprises registering in the rule table:
(a) a valid condition and an invalid condition of the definite condition,
(b) the signal values of a sending device sending the signal based on the definite rule assertion under the valid condition and the invalid condition, and
(c) the signal values of a receiving device receiving the signal based on the hold rule assertion under the valid condition and the invalid condition.

11. The method of claim 9, wherein generating the verification information comprises generating, based on the rule table, a second assertion comprising a second premise description indicating a second premise of the non-formulation behavior of the verification object circuit and a second specification description indicating a second specification of the non-formulation behavior based on the second premise.

12. The method of claim 10, wherein generating the verification information comprises generating, based on the rule table, a second assertion comprising a second premise description indicating a second premise of the non-formulation behavior of the verification object circuit and a second specification description indicating a second specification of the non-formulation behavior based on the second premise.

13. The method of claim 9, wherein generating the verification information comprises generating, based on the rule table, a second test pattern in which the signal value is randomly determined when the signal is invalid in the first test pattern.

14. The method of claim 10, wherein generating the verification information comprises generating, based on the rule table, a second test pattern in which the signal value is randomly determined when the signal is invalid in the first test pattern.

15. The method of claim 11, wherein generating the verification information comprises generating, based on the rule table, a second test pattern in which the signal value is randomly determined when the signal is invalid in the first test pattern.

16. The method of claim 12, wherein generating the verification information comprises generating, based on the rule table, a second test pattern in which the signal value is randomly determined when the signal is invalid in the first test pattern.

17. A computer readable medium comprising a computer program code for logic verification, the computer program code comprising:
accepting a first assertion and a first test pattern, the first assertion comprising:
(a) a first premise description indicating a first premise of a formulation behavior of a verification object circuit, and
(b) a first specification description indicating a first specification of the formulation behavior based on the first premise,
wherein the first test pattern is used to verify the formulation behavior of the verification object circuit;
extracting a definite rule assertion and a hold rule assertion by analyzing the first assertion accepted by the input module, wherein the definite rule assertion indicates a definite condition used to define a signal value of the verification object circuit and the hold rule assertion indicates a hold condition used to hold the signal value of the verification object circuit;
generating a rule table indicating a relationship between the definite condition and a signal of the verification object circuit based on the definite rule assertion and the hold rule assertion extracted by the extracting module; and
generating verification information used to verify a non-formulation behavior of the verification object circuit which is not included in the first assertion and the first test pattern, based on the rule table generated by the table generator.

18. The medium of claim 17, wherein generating the rule table comprises registering, in the rule table:
(a) a valid condition and an invalid condition of the definite condition,
(b) the signal values of a sending device sending the signal based on the definite rule assertion under the valid condition and the invalid condition, and
(c) the signal values of a receiving device receiving the signal based on the hold rule assertion under the valid condition and the invalid condition.

19. The medium of claim 17, wherein generating the verification information comprises generating, based on the rule table, a second assertion comprising a second premise description indicating a second premise of the non-formulation behavior of the verification object circuit and a second specification description indicating a second specification of the non-formulation behavior based on the second premise.

20. The medium of claim 18, wherein in generating the verification information comprises generating, based on the rule table, a second assertion comprising a second premise description indicating a second premise of the non-formulation behavior of the verification object circuit and a second specification description indicating a second specification of the non-formulation behavior based on the second premise.
